(19) United States
(12) Patent Application Publication
(10) Pub. No.: US 2015/0056438 A1
(43) Pub. Date: Feb. 26, 2015

(54) Hollow Silica Particles, Method of Manufacturing the Same, Composition Including the Same and Sheet with Inner Cavities

(71) Applicant: Sukgyung AT Co ., Ltd., Ansan-city (KR)

(72) Inventors: Hyung Sup Lim, Ansan-City (KR); Hyung Jun Lim, Anyang-city (KR); Young Cheol Yoo, Ansan-city (KR); O Sung Kwon, Gunpo-city (KR)

(21) Appl. No.: 14/460,776

(22) Filed: Aug. 15, 2014

Related U.S. Application Data
(60) Provisional application No. 61/868,183, filed on Aug. 21, 2013.

(51) Int. Cl. C08J 9/26; B05D 3/06; C09D 5/00

(52) U.S. Cl. CPC C08J 9/26; C09D 5/00; B05D 3/067; C08J 2201/042; C08J 2383/04
USPC 428/313.9; 521/61; 521/54; 428/402; 427/553; 427/373; 427/557

(57) ABSTRACT

Disclosed are hollow silica particles having oil absorption ratio of at most 0.1 ml/g, porosity of hollow particles when mixed with a resin of at least 90%, and melting temperature of 130-200° C., and including a silicon compound having an organic group as a main component, and a composition including the hollow silica particles. A sheet including a base and a coating layer formed on the base and including a resin, and a method of manufacturing the same are provided. The coating layer includes a plurality of inner cavities, and components of the hollow particles are attached to the inner circumference of the inner cavities. The sheet has good transparency and insulation performance, and the inner cavities may be formed by simply melting hollow particles.

### CROSS-REFERENCE TO RELATED APPLICATION

This application claims priority to U.S. Application No. 61/868,183 filed on Aug. 21, 2013 and all the benefits accruing therefrom under 35 U.S.C. §119, the contents of which are incorporated by reference in their entirety.

### BACKGROUND

The present disclosure relates to hollow silica particles having multiple physical properties, a method of manufacturing the same, a composition including the hollow silica particles, and a sheet with a plurality of inner cavities.

Recently, the use of glasses as exterior materials is increasing, and the ratio of heat loss via windows among energy for air conditioning and heating is about 39% and forms the largest portion. Thus, a method for improving energy consumption is urgent, and it is necessary to reinforce the insulation performance of window.

In Japanese Patent Publication No. 2006-145970, a crude ore material in which spherical space forming an inverse opal structure by using minute particles is filled with liquid crystals forming an isotropic phase is disclosed. However, when silica is used as the minute particles, a removing process using a hydrofluoric acid solution is necessary, which is not eco-friendly.

According to a method disclosed in WO 2007/124814, inverse opal is manufactured by regularly arranging mold spheres, removing spheres, removing cores, and impregnating gaps between the spheres with a precursor of a wall material to form a wall material, and the manufacturing process is complicated. Thus, to manufacture a sheet with inner cavities formed in a coating layer, a simple and eco-friendly process and development of materials necessary for the process are required.

### SUMMARY

The present disclosure provides a sheet having a structure including inner cavities formed in a coating layer by using hollow particles as an inner hollow forming material.

In addition, a plurality of inner cavities is easily formed in a sheet by a simple process using the difference between the melting temperature (Tm) of hollow particles and the curing temperature of a resin, thereby minimizing energy required for the manufacture of the sheet.

The present disclosure also provides an eco-friendly method of manufacturing a sheet including inner cavities without performing a separate process of removing hollow particles for forming the inner cavities.

In accordance with an exemplary embodiment of the present invention, there is provided hollow silica particles having oil absorption ratio of at most about 0.1 ml/g, porosity of the hollow particles when mixed with a resin of at least about 90%, and melting temperature (Tm) in the range from about 130 to about 200° C., and including a silicon compound having an organic group as a main component. At least one functional group selected from the group consisting of an —OH group, a methyl group, an ethyl group, a phenyl group, an acryl group, and an epoxy group may be included at the surface of the particles. The coefficient of variation of particle distribution (CV) of the particles may be at most about 10%. The particles may be monodispersed particles and real spherical type particles having sphericity of at least about 0.9. The thickness of a shell may be from about 10 to about 50% of an average particle diameter of the particles.

In accordance with another exemplary embodiment of the present invention, a method of manufacturing hollow silica particles includes (a) a step of forming silane droplets by adding alkoxysilane in an aqueous solution and stirring, (b) a step of hydrolyzing the silane by adding an acid in the aqueous solution including the alkoxysilane, (c) a step of forming first particles through bonding between the silane droplets by adding an aqueous alkaline solution in the reaction solution of step (b), (d) a step of forming shells by polymerizing the first particles by stirring the reaction solution including the aqueous alkaline solution, (e) a step of forming cavities by etching the inner part of the shells using an organic solvent, and (f) a step of filtering a solution and drying.

The alkoxysilane may be phenyl-based alkoxysilane or alkoxysilane having an organic group other than a phenyl group, or a mixture of the phenyl-based alkoxysilane and the alkoxysilane having an organic group other than a phenyl group. The mixture of the alkoxysilane may be obtained by mixing at least about 80 wt % of the phenyl-based alkoxysilane and at most about 20 wt % of the alkoxysilane having an organic group other than a phenyl group. Particularly, the phenyl-based alkoxysilane may be PTMS, and the first particles manufactured by the above-described method may have a PPSQ structure.

In the method, the pH of the reaction solution after adding the acid in step (b) may be from about 1 to about 5, and stirring time in step (b) may be from about 0.5 to about 10 minutes. The pH of the reaction solution after adding the aqueous alkaline solution in step (c) may be at least about 10, and the aqueous alkaline solution may be an alkylamine solution selected from the group consisting of NH₄OH, tetramethyl ammonium hydroxide (TMAH), octylamine (OA, CH₃(CH₂)₆CH₂NH₂), dodecylamine (DDA, CH₃ (CH₂)₁₀ CH₂NH₂), hexadecylamine (HAD, CH₃(CH₂)₁₄CH₂NH₂), 2-aminopropanol, 2-(methylphenylamino)ethanol, 2-(ethylphenylamino)ethanol, 2-amino-1-butanol, (diisopropylamino)ethanol, 2-diethylamino ethanol, 4-aminophenylaminoisopropanol, N-ethylaminoethanol, monoethanolamine, diethanolamine, triethanolamine, monoisopropanolamine, diisopropanolamine, triisopropanolamine, methyldiethanolamine, dimethylmonoethanolamine, ethyldiethanolamine, and diethylmonoethanolamine.

A reaction temperature in steps (b) and (d) may be from about 40 to about 80° C., and the method may further include (g) a step of sonicating a filtered material after performing filtering in step (f).

In accordance with another exemplary embodiment of the present invention, a composition includes the hollow silica particles having the characteristic physical properties of the present invention, a resin, and a solvent. The hollow silica particles may be included at a ratio of about 30 to about 80 wt %, and the resin may be included at a ratio of about 20 to about 70 wt % based on the total amount of the composition.

The resin may be a thermosetting resin, and the thermosetting resin may be at least one selected from a phenol resin, an epoxy resin, and a melamine resin, or a mixture thereof. The initial curing temperature of the resin may be lower than the melting temperature (Tm) of the hollow silica particles so that the hollow silica particles may not be melted. In addition, the resin may be a UV curable resin, and at least one selected from acrylate-based polymer resins or a mixture thereof may be used.

Since a polyimide (PI) resin, a C-PVC resin, a PVDF resin, an ABS resin, and CTFE are resins having low thermal conductivity, these resins may be mixed with the thermosetting resin or the UV curable resin having a lower initial curing temperature than the melting temperature (Tm) of the hollow silica particles. Thus, the insulation effect of the coating layer may be increased.

In order to enhance functionality, a hard coating agent, a UV blocking agent, and an IR blocking agent could be added to the above composition.

In accordance with still another exemplary embodiment of the present invention, a sheet includes a base, and a coating layer formed on the base and including a resin as a main component. The coating layer includes a plurality of inner cavities formed therein, and components of hollow particles are attached to a portion of an inner circumference of the inner cavities. The components of the hollow particles may be silicon compounds having an organic group.

The plurality of the inner cavities may be separated from each other in the coating layer including the resin as a main component. The plurality of the inner cavities may have the same size when monodispersed hollow particles by an inner cavity forming material are used. Alternatively, the plurality of the inner cavities may be disposed in a plurality of layers according to the size gradient of the inner cavities by using monodispersed hollow particles having at least two different sizes. The diameter of the inner cavities may be at least 40 nm, or may be at most 500 nm. The resin which is the main component of the coating layer may be a thermosetting resin or a UV curable resin. The sheet may have insulation function due to an air layer in the inner cavities and may additionally have UV blocking function and IR blocking function. The base of the coating layer may be a sheet of a polymer material, a fiber, a film or glass.

In accordance with further still another exemplary embodiment of the present invention, a method of manufacturing a sheet includes (a) forming a coating layer by coating the composition including hollow silica particles having the characteristic physical properties of the present invention, a resin and a solvent on a base, (b) curing the coating layer, and (c) forming a plurality of inner cavities by melting hollow silica particles in the coating layer. The coating layer may be cured by heat curing or UV curing or at a temperature lower than the melting temperature of the hollow particles. After curing, the hollow particles in the coating layer may be melted by heat or microwave at from about 130 to about 200° C. to form the plurality of inner cavities.

According to the present invention, a plurality of inner cavities containing air in a coating layer formed by using a resin as a main component is formed in a sheet by a simple method of coating a base with a composition obtained by mixing hollow particles with a resin and then, melting the hollow particles, thereby the sheet exhibiting transparency and good insulating performance.

The hollow particles melted by heat collapse down in the direction of gravity, and the components of hollow particles are attached and remain on a portion of the inner circumference of the inner cavities. Thus, the intensity of the coating layer formed by using the resin as a main component may be increased.

In addition, since the hollow particles according to the present invention are melted at a lower temperature than the melting temperature of hollow particles formed by a common template method, energy necessary for the manufacture of the sheet with the inner cavities may be decreased.

### BRIEF DESCRIPTION OF THE DRAWINGS

Exemplary embodiments can be understood in more detail from the following description taken in conjunction with the accompanying drawings, in which:

FIGS. 1A to 1C are schematic diagrams illustrating a hydrolyzed PTMS droplet, first particles, and a particle structure with a shell formed thereon during the manufacture process according to the present invention;

FIG. 2 illustrates transmission electron microscope (TEM) photographic images of hollow silica particles having an average diameter of 100 nm in accordance with an exemplary embodiment of the present invention;

FIG. 3 is a cross-sectional view of a sheet with a coating layer including hollow silica particles and a resin in accordance with another exemplary embodiment of the present invention;

FIG. 4 is a cross-sectional view of a sheet with inner cavities formed by melting hollow silica particles in the sheet in FIG. 3; and

FIG. 5 illustrates a process of manufacturing insulating glass by forming inner cavities in the sheet in FIG. 3 by applying heat and attaching the sheet to glass.

### DETAILED DESCRIPTION OF EMBODIMENTS

The hollow silica particles having multiple physical properties of the present invention may be manufactured by the following process.

Manufacture of Hollow Silica Particles

The hollow particles of the present invention are manufactured by the following process. Alkoxysilane as a raw material is added in an aqueous solution and stirred to form droplets, and an acid is added in the aqueous solution to hydrolyze the alkoxysilane droplets. In the reaction solution, an alkaline aqueous solution is added to combine the silane droplets with each other and to form first particles. By stirring the reaction solution, the first particles are polymerized to form shells. The inner portion of the shell is etched to form hollow, followed by filtering, drying to manufacture a final particle powder. Hereinafter, the manufacturing process of the hollow silica particles of the present invention will be explained in detail.

1. Raw Material

Alkoxysilane is used as a raw material of hollow silica particles. Alkoxysilane-based compound includes epoxy-based alkoxysilane, vinyl-based alkoxysilane, acryl-based alkoxysilane, phenyl-based alkoxysilane, alkyl-based alkoxysilane, amino-based alkoxysilane, etc. Particularly, the alkoxysilane-based compound may be at least one selected from the group consisting of the phenyl-based alkoxysilane and alkoxysilane containing an organic group other than a phenyl group, or a mixture thereof. The phenyl-based alkoxysilane includes, for example, phenyltriethoxysilane (SiO₃C₁₂H₂₀), phenyltrimethoxysilane (SiO₃C₉H₁₄), diphenyldiethyoxysilane (SiO₂C₁₆H₂₀), diphenyldimethoxysilane (SiO₂C₁₄H₁₆), etc. In addition, a mixture of the phenyl-based alkoxysilane and the alkoxysilane containing the organic group other than the phenyl group may be used. In this case, a mixture of at least about 80 wt % of the phenyl-based silane and at most about 20 wt % of the silane other than the phenyl-based silane may preferably be used. Particularly preferably, phenyltrimethoxysilane (PTMS, C₉H₁₄O₃Si) having a structure of the following Formula 1 may be used as the phenyl-based alkoxysilane.

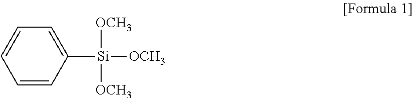 [SMILES: CO[Si](OC)(OC)c1ccccc1]

2. Formation of Droplets

When the alkoxysilane is added in an aqueous solution, the alkoxysilane is not miscible with the aqueous solution, and a layer separation may be generated. By continuing stirring, silane droplets may be formed and dispersed in water.

3. Hydrolysis of Droplets

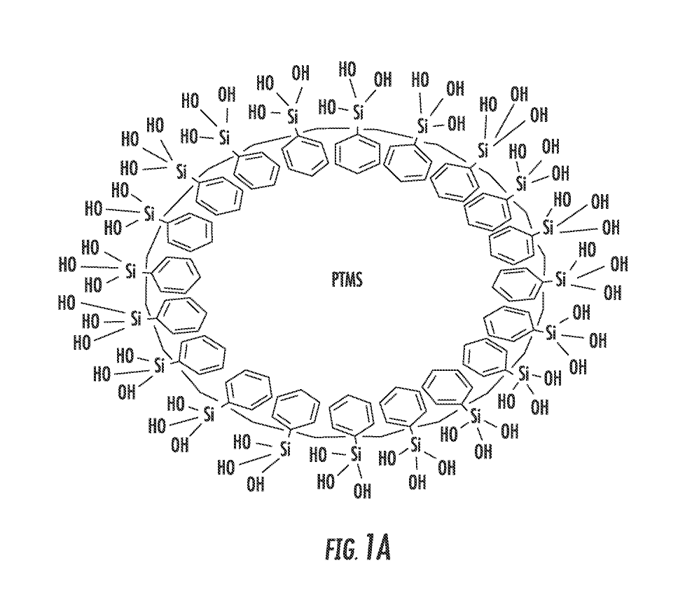

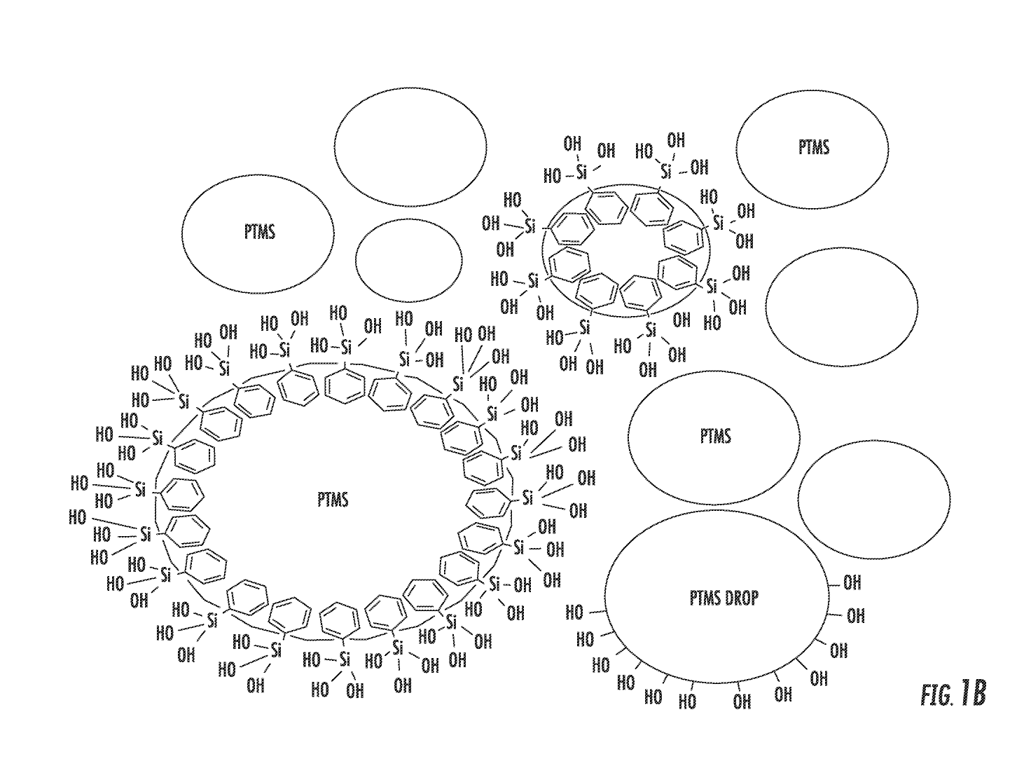

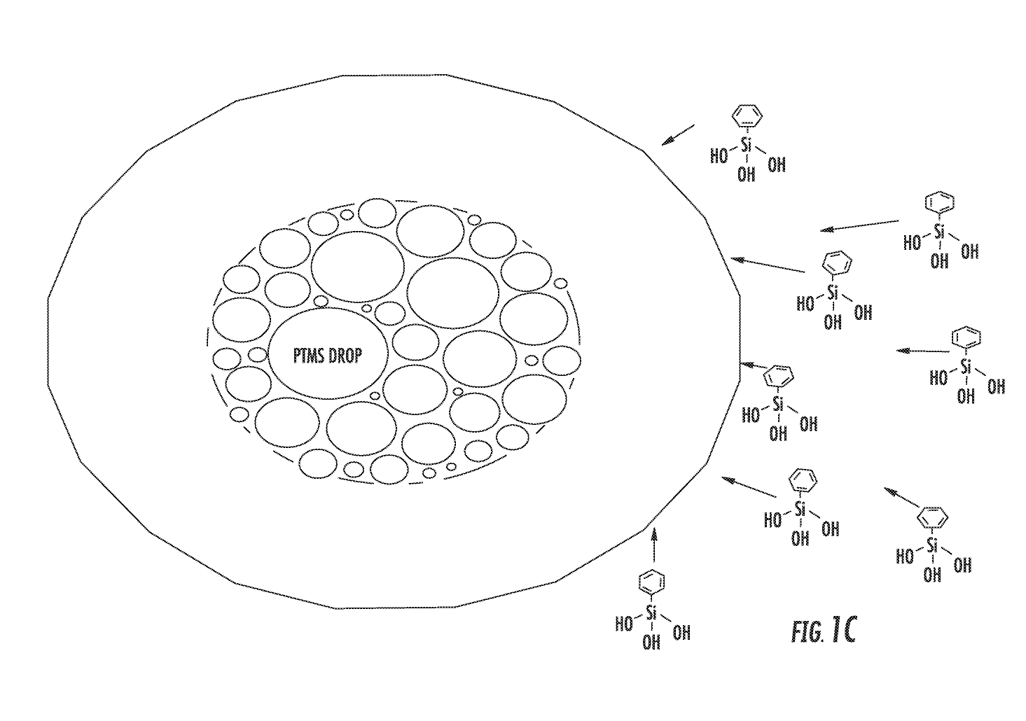

When an acid is added in the aqueous solution, an —OR group of the alkoxysilane is replaced with an —OH group by the catalytic function of the acid, as shown in FIG. 1A. Through continuing stirring, the hydrolyzed silane droplets may be uniformly mixed in the aqueous solution. As the acid, HCl, HNO₃, H₂SO₄, etc. may be used, and pH of the reaction solution is preferably from about 0.5 to about 5. When the pH of the reaction solution is low, the chain of the silane may be broken, and the particle size may be decreased. When the amount of the silane is increased, the reaction of forming a gel shape may be easily performed, or hollow may not be formed in the particles, thereby disturbing the formation of the hollow in the particles and hindering the control of the production of the particles. In addition, when the pH is at least about 5, and the amount of the silane is small, the formation of the particles and the hollow may be difficult.

Meanwhile, as stirring time increases after adding the acid, the size of finally produced particles may decrease, or the particles may be aggregated to form gel and to disturb the formation of the hollow. When the stirring time is too short, the hydrolysis of the silane droplets may be insufficiently performed, and the production of the hollow particles may become difficult. Preferably, the stirring time is from about 0.5 to about 10 minutes, and more preferably, the stirring time is from about 1 minute to about 5 minutes.

The size of droplets depends on the stirring rate of a reactor and the size of the final particles may be determined according to the size of the droplets. Thus, the stirring rate is preferably more than 200 rpm and it is possible to obtain particles size of several nanometers (nm) to several micrometer (μm) in diameter.

When the reaction is performed at about 40° C. or less, the production of particles may be difficult, and the particles may be aggregated to form gel in a high concentration. In this case, the thickness of the shell may increase to decrease the size of the hollow. When the reaction is performed at greater than about 80° C., an alkaline material may volatilize, and the control of the reaction conditions may be difficult. In this case, the inner part of the shell may not be melted, and the hollow particles may not be formed. Thus, the temperature during the reaction is preferably from about 40° C. to about 80° C. Meanwhile, the hydrolysis reaction formula of PTMS is as follows.

PhSi(OMt)₃+H₂O→PhSi(OH)(OMt)₂

PhSi(OH)(OMt)₂+H₂O→PhSi(OH)₂(OMt)

PhSi(OH)₂(OMt)+H₂O→PhSi(OH)₃ [Reaction Formula 1]

4. Formation of First Particles

When an alkaline solution is added in the hydrolyzed alkoxysilane solution, the alkaline solution plays the role of a catalyst, and first particles are formed through the reaction between silane droplets as shown in FIG. 1B. The alkaline solution may include an alkaline material such as NaOH, Ca(OH)₂, KOH, NH₄OH, etc. preferably NH₄OH, and an inorganic alkaline material such as alkylamine. The preferable pH of the total reaction solution is at least about 10. The alkylamine may be selected from the group consisting of NH₄OH, tetramethyl ammonium hydroxide (TMAH), octylamine (OA, CH₃(CH₂)₆CH₂NH₂), dodecylamine (DDA, CH₃(CH₂)₁₀CH₂NH₂), hexadecylamine (HDA, CH₃(CH₂)₁₄CH₂NH₂), 2-aminopropanol, 2-(methylphenylamino)ethanol, 2-(ethylphenylamino)ethanol, 2-amino-1-butanol, (diisopropylamino)ethanol, 2-diethylaminoethanol, 4-aminophenylaminoisopropanol, N-ethylaminoethanol, monoethanolamine, diethanolamine, triethanolamine, monoisopropanolamine, diisopropanolamine, triisopropanolamine, methyldiethanolamine, dimethylmonoethanolamine, ethyldiethanolamine, and diethylmonoethanolamine.

At the temperature less than about 40° C., the particles may be easily aggregated and form a gel state. Thus, the production of hollow particles may be difficult, and the thickness of the shell may become too large and the size of the hollow may become too small. When the reaction temperature exceeds about 80° C., the alkaline material may volatilize, and the control of the reaction conditions may become difficult. In this case, the inner part of the shell may not be melted, and the hollow particles may not be formed. Thus, the temperature may preferably be performed at from about 40 to about 80° C.

2Ph-Si(OH)₃→Ph-Si(OH)₂—O—Si(OH)₂-Ph [Reaction Formula 2]

5. Formation of Shell

By stirring the aqueous solution in which the alkaline solution is added, the first particles are polymerized by siloxane bonds to form insoluble shells in inorganic solvents. The thickness of the shell is preferably from about 5% to about 45% of the average diameter of the silica particles. In the case that the particles are formed by using the PTMS as a raw material, the structure of the shell has a networked PPSQ structure as illustrated in the following Formula 2.

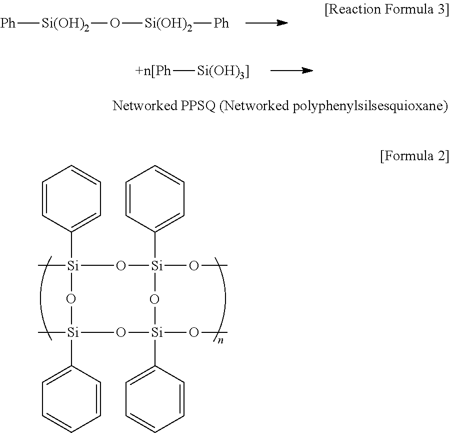

6. Etching

In the insoluble shell, unreacted alkoxysilane oligomer and unreacted droplets are present, and by etching thereof using organic solvents, the hollow in the shell may be formed. The organic solvent includes ethanol, methanol, etc., and may include commonly used organic solvents.

Meanwhile, sonication was additionally performed with respect to filtered materials by using a sonicator to remove the impurities at the surface of the particles to smoothen the surface of the particles. The sonication was performed for from about 5 seconds to about 40 minutes.

7. Filtering and Drying

The filtered materials were dried in a vacuum oven for about 1 to about 10 hours, and evaporation of water or sublimation is generated at a corresponding temperature to vacuum degree to perform the drying.

Hollow silica particles thus produced were treated with a silane coupling agent, and a modification step of the surface of the particles by a known method such as nitration, sulfonization, aminization, halogenation, etc., may be further performed.

As described above, a template such as a metal oxide is not necessary for the manufacture of the hollow particles of the present invention, and a baking process requiring lots of time and high energy cost is not necessary. Thus, hollow silica particles having multiple physical properties may be obtained through a simple manufacturing process.

Physical Properties of Hollow Silica Particles

The hollow silica particles obtained by the above manufacturing method includes a silicon compound having an organic group as a main component, and having oil absorption ratio of at most about 0.1 ml/g, porosity of at least about 90% when mixed with a resin, and a melting temperature (Tm) of from about 130° C. to about 200° C. In addition, the hollow silica particles may be monodispersed particles having the coefficient of variation of particle distribution (CV value) of at most about 10%. The thickness of the shell may be from about 10% to about 50% of the average particle diameter, and the particles may be real spherical type particles having sphericity of at least about 0.9.

Hereinafter, the physical properties and the measuring method of the hollow silica particles of the present invention will be explained together.

1) Melting Temperature (Tm)

In the present invention, the Tm of the hollow silica particles was measured by means of a differential scanning calorimeter (DSC).

DSC is model DSC 200P of NETZSCH Co. equipped with a thermal analysis data processing apparatus, and the temperature was calibrated using indium (Tm=156.6° C., ΔHf=28.5 J/g). In this experiment, the most widely used midpoint rule was used as an experimental method, and Tm was obtained by measuring the temperature at the maximum peak. From the measured results, the melting temperature of the hollow particles of the present invention was secured to be in the range of about 130° C. to about 200° C.

2) Oil Absorption Ratio

The hollow silica particles manufactured by a common template method includes lots of large-sized micropores at the surface thereof, and a separate baking process and a surface treatment are required after manufacturing. However, since the surface of the hollow particles of the present invention includes very small micropores, the surface of spherical shapes thereof is substantially smooth, and the above-described treatments are not required. Here, the expression of “smooth” means that an optional uneven part such as depressions, gaps, flaws, cracks, protrusions, grooves, etc. are not present at the surface of the shell. The smoothness of the particles of the present invention may be measured by a scanning electron microscope (SEM) and may be secured through oil absorption ratio, the porosity of a mixture with a resin, etc.

The oil absorption ratio was measured by using a rub-out method (ASTM D281). This method is based on the principle of mixing linseed oil and silica by rubbing the mixture of the linseed oil and the silica on the smooth surface by using a spatula until a stiff putty type paste is formed. By measuring the amount of the oil necessary for forming a curl paste mixture during spraying, the oil absorption ratio of the silica may be calculated. The oil absorption ratio represents the volume of the oil per unit weight of the silica necessary for the saturation of silica absorption capability. The high degree of the oil absorption ratio means that lots of the micropores or large-sized micropores are present at the surface of the silica particles, and the low degree of the oil absorption ratio means that the micropores are rarely present at the surface of the shell of the silica particles. The oil absorption ratio may be determined by the following equation:

Oil absorption ratio=oil amount ml/silica 100 g

3) Porosity

The porosity means the ratio of the pores in the particles, and may be verified by the amount of a resin absorbed in the hollow when the hollow silica particles are mixed with the resin. The amount of the resin absorbed in the hollow may be measured by the same method as that used for the oil absorption ratio. When the amount of the resin absorbed is small, large volume of the hollow may be maintained in the particles.

At the surface of the particles of the present invention, very small micropores are present, and the amount of the resin absorbed in the hollow of the particles is very small when the particles are immersed in the resin. Thus, when the porosity is large, the space including air in the particles also is large.

4) Coefficient of Variation of Particle Distribution (CV Value) (Monodispersibility)

An image of the particles was taken by using a field emission scanning electron microscope (FE-SEM, JSM-6701F of JEOL Co.) with the magnification of 250,000 times. With respect to 250 particles in the image, the CV value of particle diameter distribution was calculated by using an image interpretation apparatus and by measuring an average particle diameter. Particularly, the particle diameters of 250 particles were measured, and the average particle diameter and the standard deviation of the particle diameter were obtained. Then, the CV value was calculated from the following equation.

Coefficient of variation of particle distribution(CV(%))=(standard deviation of particle diameter(σ)/average particle diameter(Dn))×100

In the case that the CV value is large, particles having various sizes are mixed, and the specific surface area thereof may increase, and the filling factor of the hollow particles may be at most 50% during preparing a mixture composition with a resin. Thus, the manufacture of a sheet having good properties such as transparency, insulating properties, intensity, etc. may be difficult.

5) Sphericity

The analysis of the properties of the silica particles with a round shape according to the present invention is performed by using a field emission scanning electron microscope (FE-SEM, JSM-6701F of JEOL Co.) illustrating the cross-sectional structure of the particles, and the sphericity was expressed by the ratio (DS/DL) of a short diameter (DS) and a long diameter (DL). Typical samples of the silica particles were collected and tested by a scanning electron microscope (SEM). The sphericity of the particles may be calculated by the following equation.

Sphericity=circumference²/4π×area

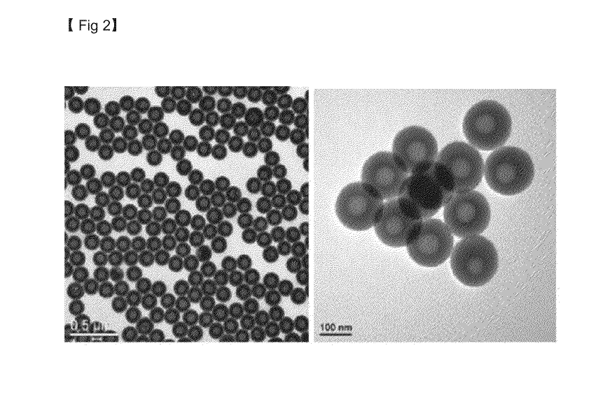

In the above equation, the circumference is measured circumference of software induced from the configuration analyzed tracking of the particles, and the area is measured area of software in the tracked circumference of the particles. The calculation is performed for each of appropriate particles in the SEM image. The values are classified according to the values, and lower values within 20% among the values are discarded. The remaining values within 80% among the values are averaged. The coefficient of sphericity for the particles in FIG. 2 (S₈₀) was 0.98. As understood from the microscopic image in FIG. 2, the sphericity of the particles of the present invention is at least 0.9, and the particles have a spherical shape close to a real sphere.

6) Thickness of Shell

The “average diameter” is understood as a diameter obtained by averaging the diameters of all particles in the sample.

Typical samples of the silica particles were collected and the diameter of the silica particles was measured by using FE-SEM (JSM-6701F of JEOL Co.). The inner diameter of the hollow part was measured by using a transmission electron microscope (TEM, TECNAI G2 F30 S-TWIN of FEI Co.).

The particles have an appropriate thickness so that the particles do not break during the preparation of a composition, and the hollow ratio is large to provide large inner hollow. In the case that the thickness of the shell is too large, the volume of the inner hollow is decreased and the insulation performance may be deteriorated, or the hollow may be blocked. In the case that the thickness of the shell is too small, the particles may be broken. The thickness of the cell of the hollow silica particles of the present invention is preferably from about 10 to about 50% of the average particle diameter.

7) Functional Group

The particles may include at least one functional group selected from the group consisting of an —OH group, a methyl group, an ethyl group, a phenyl group, an acryl group, and an epoxy group at the surface thereof.

Composition for Coating Including Hollow Silica Particles and Resin

In another embodiment of the present invention, a composition for forming a coating layer on a base is provided. The composition of the present invention may be prepared by mixing the hollow silica particles with multiple physical properties as described above, a resin, an organic solvent, etc.

About 30 to about 80 wt % of the hollow silica particles and about 20 to about 70 wt % of the resin based on the total amount of the composition are preferably mixed. In the case that the composition is used as a hollow forming material during manufacturing a sheet with the amount of the hollow silica particles less than about 30 wt %, the volume of the inner cavities in a coating layer may be small, and the effect of the sheet may be insufficiently attained. In the case that the amount of the hollow silica particles exceeds about 80 wt %, the amount of the resin may be decreased, and curing efficiency may be deteriorated.

The resin may be a thermosetting resin or a UV curable resin. For the thermosetting resin, the melting of the hollow silica particles during curing after coating may be prevented when the initial curing temperature of the resin is lower than the melting temperature (Tm) of the hollow silica particles. The thermosetting resin may be selected from a phenol resin, an epoxy resin, a melamine resin, etc., and a mixture thereof may be used. The UV curable resin may be composed of an oligomer, a monomer, a photopolymerization initiator, and various additives. The oligomer is an important component controlling the physical properties of the resin and making a polymer bond via polymerization reaction to form a cured coating layer. According to the structure of a skeleton molecule, the oligomer may be classified as a polyester-based, an epoxy-based, a urethane-based, a polyether-based, a polyacryl-based oligomer, etc. The UV curable resin may be selected from an acrylate-based polymer resin such as an epoxy acrylate, a urethane acrylate, a high refractive index acrylate, a polyester acrylate, a silicone acrylate polymer resin, etc.

In addition, resins having a low thermal conductivity such as a polyimide (PI) resin, a C-PVC resin, a PVDF resin, an ABS resin, and CTFE may be mixed with the thermosetting resin and the UV curable resin. The thermal conductivity of a general UV curable resin is from about 0.2 to about 0.4 W/m·K, however the thermal conductivity of polyimide (PI) is about 0.19 W/m·K, the thermal conductivity of C-PVC is about 0.14 W/m·K, the thermal conductivity of PVDF is about 0.13 W/m·K, the thermal conductivity of ABS is about 0.17 W/m·K, and the thermal conductivity of CTFE is about 0.13 W/m·K. Since the thermal conductivity of the resins are in the range of about 0.1 to about 0.2 W/m·K, a coating layer formed by using a mixture of the resins with the thermosetting resin and the UV curable resin may have an insulation performance.

In the coating composition, a hard coating agent, a UV blocking agent, or an IR blocking agent may be additionally included, and the additive may be commonly known materials. Besides, an additive imparting additional function may be included as occasion demands.

The “composition” used in the present invention represents a liquid, liquefiable, or mastic composition that may be transformed into a solid film after application and includes silica. The composition may be applied on the inner part or the outer part of the surface of a structure.

The composition may maintain the integrity of a polymer and a pigment matrix, that may be present in the coating, may exhibit good insulation properties, and may be used in an insulating sheet, in a house with a window, in the field of construction, and for coating a window of a vehicle, etc.

Sheet with Inner Cavities Formed Therein

In another embodiment of the present invention, a sheet including a coating layer with inner cavities formed therein may be manufactured.

A sheet 1 of the present invention includes a base 100, a coating layer 200 formed on the surface of the base and including a resin 230 as a main component. In the coating layer, a plurality of inner cavities 210 are formed, and on a portion of the inner circumference of the inner cavities, the components of the hollow particles 400 are attached.

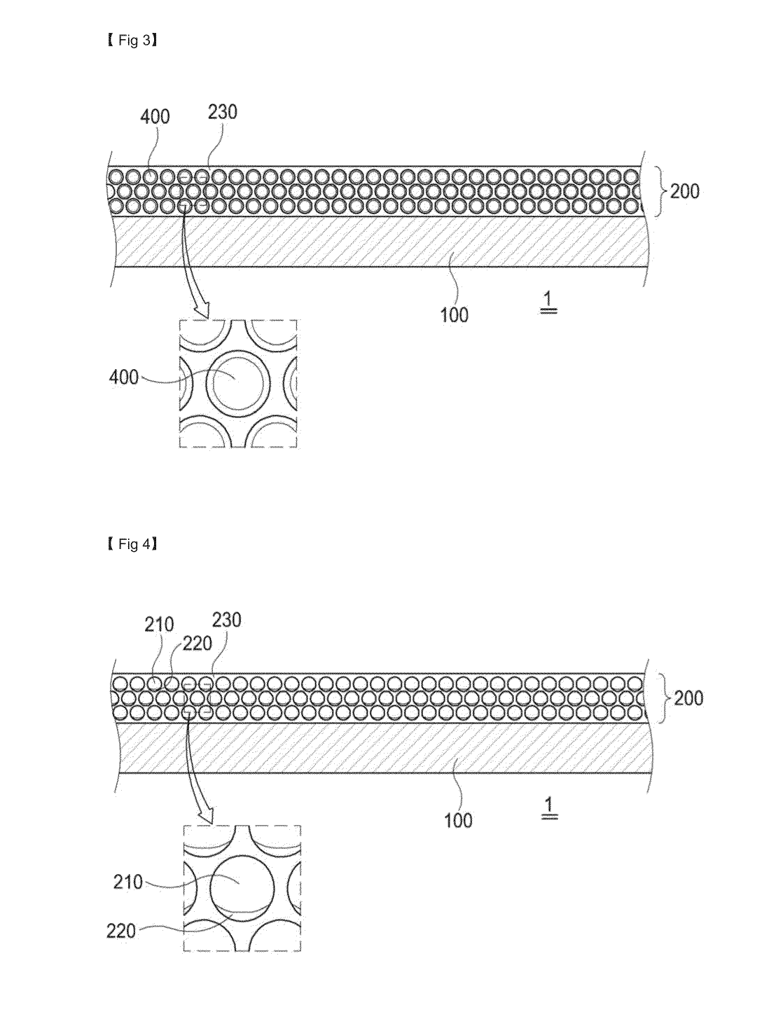

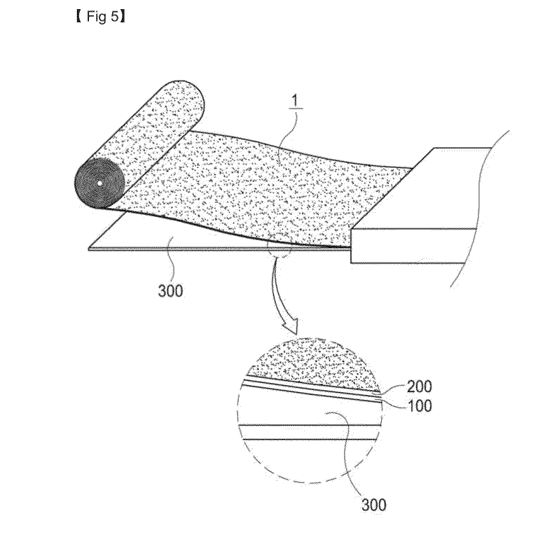

FIG. 3 illustrates a sheet manufactured by coating a composition including hollow particles 400 and a resin 230 on a base to form a coating layer 200 and curing, FIG. 4 illustrates a sheet with inner cavities 210 formed by melting hollow silica particles in the coating layer 200, wherein the components of the hollow particles 220 are attached on a portion of the inner cavities. The plurality of the inner cavities 210 in the coating layer are formed through the melting of the hollow particles mixed with the resin during the formation of the coating layer. The plurality of the inner cavities are separated from each other, and when monodispersed hollow particles are used as a cavity forming material, the size of the particles may be uniform. In addition, a sheet with relatively small cavities having a diameter of less than or equal to about 500 nm may be formed, and a sheet with the inner cavities having a diameter of at least 40 nm may be formed.

The hollow particles may be melted and collapsed down by heat treatment or microwave, and the components of the hollow particles 200 may be attached to and remain on a portion of the inner circumference of the inner cavities as shown in FIG. 4. The components of the hollow particles are silicon compounds with an organic group such as SiO₂, PPSQ, etc. The hardness of the coating layer may increase because of the remaining components of the hollow particles.

Meanwhile, the resin 230 is cured in the space between the inner cavities, and the resin may be a thermosetting resin or a UV curable resin. The main component of the coating layer is the resin, and the coating layer may additionally have UV blocking and IR blocking function according to the added additives in the composition. The coating layer may have properties such as transparency and insulating properties due to an air layer in the inner cavities.

The base may be a sheet, a fiber, a film or glass of a polymer material. The base is not specifically limited and includes, for example, an inorganic base represented by glass, a metal base, an organic base represented by polycarbonate, polyethyleneterephthalate, an acryl resin, a fluorine resin, a triacetyl cellulose resin, and a polyimide resin. Preferably, the sheet, the fiber, the film, or the glass of the polymer material is used, and particularly, the film base may be a commonly used film such as PET, PE, etc. The base may be a single base or may be obtained by stacking different materials. In addition, at least one extra layer may be formed on the surface of the base in advance. For example, the extra layer may be a ultraviolet curable hard coat layer, an electron beam curable hard coat layer, a thermosetting hard coat layer, etc. As the coating method, an appropriate and optional coating method known in this art may be used. After coating, the coating layer is cured by heat or UV lights.

The thickness of the coating layer may be optionally selected and controlled according to the product and use thereof, and may preferably be from about 1 to about 500 μm. In the case that the thickness is deviated from the above range, the thermal conductivity may increase or the transmittance of visible lights may be deteriorated. The coating layer may additionally have UV blocking function and IR blocking function, and a UV blocking layer and an IR blocking layer may be separately stacked on the coating layer. In addition, the sheet of the present invention may have transparent and insulation properties with the transmittance of visible lights of at least about 70%, and the thermal conductivity of less than about 0.03 W/m·K. The thermal conductivity was measured by using two disc type sheets having a diameter of about 30 cm, and a thickness of about 20 mm as measuring samples. As a measuring apparatus, a thermal conductivity measuring apparatus for a guarded hot plate method (manufactured by Eiko Seiki Kabushiki Kaisha) may be used. The hardness of the coating layer was tested by scratching the surface of the coating layer using a pencil with the angle of 45 degrees and the load of 1 kg under the conditions of a test temperature of (23±2)° C. and the relative humidity of (50±5)%. The generation of scratches was observed, and the pencil may be UNI of Mitsubishi.

Manufacturing Method of Sheet with Inner Cavities Formed Therein

Meanwhile, a method of manufacturing a sheet with inner cavities will be explained as another embodiment of the present invention with reference to attached drawings.

The method of manufacturing the sheet includes a step of forming a coating layer by coating a composition including the hollow particles of the present invention on a base, a step of curing the coating layer, and a step of forming a plurality of inner cavities by melting the hollow particles in the coating layer and attaching the components of the hollow particles to a portion of the inner circumference of the inner cavities.

That is, a coating layer including hollow particles is formed and cured to form a sheet, and the hollow particles in the coating layer are melted to remain only the shape of the hollow particles to form a plurality of inner cavities. The components of the hollow particles are melted down and attached to a portion of the inner circumference of the cavities and remain. The curing may be heat curing or UV curing according to the resin that is a main component of the coating layer. During heat curing, the initial curing temperature of the coating layer is lower than the melting temperature of the hollow particles so that the hollow particles are not melted and present in the coating layer. With respect to the UV curing, the coating layer may be cured with 365 nm wavelength and 700 mJ.

The hollow particles in the cured coating layer may be melted by heat or microwave, and the melting temperature thereof is preferably from about 130° C. to about 200° C., and exposing time is preferably from about 1 to about 5 minutes. At the temperature, only the hollow particles are melted, and the cured resin layer remains as it is. Thus, inner cavities are formed at the place occupied by the hollow particles formerly. In addition, the components of the hollow particles are attached to the inner circumference of the cavities thus formed and remain. Here, the term of “attached” has the same meaning as “positioned at ˜” or “making contact with”. That is, through the melting of the shell of the hollow particles, inner cavities having the size of the outer diameter of the hollow particles are formed. By containing air in the inner cavities, insulation effect may be increased. Through the remaining of the components of the hollow particles, the durability of the sheet may be increased. Accordingly, the sheet of the present invention has merits including high transparency, durability, colorlessness, flexibility and applicability in a base.

FIG. 5 illustrates a process of continuously melting a coating layer including hollow particles by applying heat from about 130 to about 200° C. The sheet 1 thus manufactured is attached to glass or pane glass 300 by a commonly known method to manufacture insulating glass. The insulating glass is effective for decreasing both conduction heat transfer and convection heat transfer, and has thermal conductivity from about 0.015 to about 0.035 W/m·K, and preferably at most about 0.03 W/m·K.

Hereinafter, the present invention will be described below in more detail through embodiments. The present invention may, however, be embodied in different forms and should not be construed as limited to the embodiments set forth herein. Rather, these embodiments are provided so that this disclosure will be thorough and complete, and will fully convey the scope of the inventive concept to those skilled in the art.

### Example 1

In a 250 ml flask, water (150 ml), and phenyltrimethoxysilane (PTMS) (1 ml) were inserted, and nitric acid (60%, 0.2 ml, 2.6 mmol) was added so as to control the pH of a reaction solution to 3. The reaction solution was stirred at 60° C. for 4 minutes. Then, an aqueous ammonia solution (30%, 10 ml, 308 mmol) was added thereto, followed by stirring at 60° C. for 1 hour and 30 minutes to form shells. The inner part of the shell was etched using 20 ml of ethanol. The product thus obtained was filtered using a filtering membrane having a size of about 0.2 μm and dried at 120° C. to produce hollow silica particles as a powder state.

As shown in the TEM photographic images in FIG. 2, the particles thus produced are spherical particles and hollow particles of which inside is bright. The oil absorption ratio, the porosity when mixed with a resin, and the CV value are illustrated in the following Table 1.

### Example 2

The same procedure described in Example 1 was performed except for using a mixture of PTMS (0.8 ml) and TEOS (0.2 ml) instead of PTMS (1 ml) to produce hollow silica particles. The physical properties of the particles thus produced are illustrated in the following Table 1.

### Example 3

The same procedure described in Example 1 was performed except for using a mixture of PTMS (0.8 ml) and VTMS (0.2 ml) instead of PTMS (1 ml) to produce hollow silica particles. The physical properties of the particles thus produced are illustrated in the following Table 1.

### Example 4

The same procedure described in Example 1 was performed except for using a mixture of PTMS (0.8 ml) and MPTMS (0.2 ml) instead of PTMS (1 ml) to produce hollow silica particles. The physical properties of the particles thus produced are illustrated in the following Table 1.

### Example 5

The same procedure described in Example 1 was performed except for adding nitric acid (60%, 0.2 ml, 4 mmol) and controlling the pH of the reaction solution to 1.

### Example 6

The same procedure described in Example 1 was performed except for stirring the reaction solution after adding nitric acid for 9 minutes.

### Example 7

The same procedure described in Example 1 was performed except for stirring the reaction solution after adding nitric acid at 80° C.

TABLE 1

| | Tm | CV | Average particle | Oil absorption | Porosity |
|---|---|---|---|---|---|
| | (° C.) | (%) | diameter (nm) | ratio (ml/g) | (%) |
| Example 1 | 158 | 3.1 | 100 | 0.018 | 92 |
| Example 2 | 167 | 4.2 | 110 | 0.015 | 85 |
| Example 3 | 170 | 3.8 | 130 | 0.016 | 90 |
| Example 4 | 174 | 4.3 | 150 | 0.015 | 91 |
| Example 5 | 158 | 3 | 98 | 0.016 | 91 |
| Example 6 | 158 | 3 | 90 | 0.017 | 90 |
| Example 7 | 158 | 3 | 100 | 0.016 | 92 |

As shown in Table 1, the hollow particles produced according to Examples 1 to 7 exhibit Tm in the range of about 130 to about 200° C., have very small pore size at the surface thereof, and are monodispersed particles having uniform size.

### Example 8

Based on the total amount of a composition, 60 wt % of the hollow silica particles produced in Example 1, 30 wt % of a UV acrylate (monomers) resin, and remaining amount of known organic solvent and initiator were mixed to prepare a composition.

### Example 9

Based on the total amount of a composition, 60 wt % of the hollow silica particles produced in Example 1, 30 wt % of PVDF, and remaining amount of known organic solvent and initiator were mixed to prepare a composition.

### Example 10

Based on the total amount of a composition, 60 wt % of the hollow silica particles produced in Example 1, 30 wt % of a phenol resin, and remaining amount of known organic solvent and initiator were mixed to prepare a composition.

### Example 11

Based on the total amount of a composition, 60 wt % of the hollow silica particles produced in Example 1, 30 wt % of an epoxy resin, and remaining amount of known organic solvent and initiator were mixed to prepare a composition.

### Example 12

After coating the composition of Example 8 on one side of a PEN film by bar coating, the composition was exposed to lights with 365 nm wavelength and 700 mJ/cm² for 20 seconds by using a UV lamp and cured. On the surface of the sheet thus formed, a coating layer having a thickness of about 125 μm was formed. Heat of 135° C. was applied to the sheet for 3 minutes, followed by cooling. Then, physical properties such as thermal conductivity, the transmittance of visible light, hardness, etc. were measured, and the results are illustrated in Table 2.

### Example 13

A sheet was manufactured by using the composition of Example 9 and performing the same procedure as described in Example 12.

### Example 14

After coating the composition of Example 10 on one side of a PEN film by bar coating, the composition was cured at 86° C. for 1 minute. On the surface of the sheet thus formed, a coating layer having a thickness of about 125 μm was formed. Heat of 135° C. was applied to the sheet for 3 minutes, followed by cooling. Then, physical properties were measured, and the results are illustrated in Table 2.

### Example 15

After coating the composition of Example 11 on one side of a PEN film by bar coating, the composition was cured at 103° C. for 1 minute. On the surface of the sheet thus formed, a coating layer having a thickness of about 125 μm was formed. Heat of 135° C. was applied to the sheet for 3 minutes, followed by cooling. Then, physical properties were measured, and the results are illustrated in Table 2.

### Example 16

After coating the composition of Example 8 on one side of a PEN film by bar coating, the composition was exposed to lights with 365 nm wavelength and 700 mJ/cm² for 20 seconds by using a UV lamp and cured. On the surface of the sheet thus formed, a coating layer having a thickness of about 125 μm was formed. The sheet was attached to glass while heating at 135° C. for 3 minutes to continuously melt the hollow particles in the coating layer to form insulating glass with the insulating sheet of the present invention attached thereto.

### Example 17

After coating the composition of Example 10 on one side of a PEN film by bar coating, the composition was cured at 86° C. for 1-3 minutes. On the surface of the sheet thus formed, a coating layer having a thickness of about 125 μm was formed. The sheet was attached to glass while heating at 135° C. for 3 minutes to continuously melt the hollow particles in the coating layer to form insulating glass with the insulating sheet of the present invention attached thereto.

TABLE 2

| | | Initial | | Heat | | | |
|---|---|---|---|---|---|---|---|
| | | curing | UV | treatment | Thermal | Visible light | |
| | | temperature | wavelength/ | temperature | conductivity | transmittance | Hardness |
| | Resin | (° C.) | energy | (° C.) | (W/m · K) | (%) | (H) |
| Example | Acrylate | — | 365 nm, | 135 | 0.028 | 80 | 7 |
| 12 | | | 700 mJ/cm² | | | | |
| Example | PVDF | — | 365 nm, | 135 | 0.029 | 70 | 7 |
| 13 | | | 700 mJ/cm² | | | | |
| Example | Phenol | 86 | — | 135 | 0.021 | 75 | 7 |
| 14 | resin | | | | | | |
| Example | Epoxy | 112 | — | 135 | 0.020 | 70 | 7 |
| 15 | resin | | | | | | |
| Example | Acrylate | | 365 nm, | 135 | 0.022 | 75 | 7 |
| 16 | | | 700 mJ/cm² | | | | |
| Example | Phenol | 86 | | 135 | 0.021 | 70 | 7 |
| 17 | resin | | | | | | |

The sheets formed according to the above Examples 12 to 15 include a plurality of inner cavities formed therein, and have thermal conductivity of at most 0.03 W/m·K and good insulation performance, visible light transmittance of at least 70% and good transmittance, and hardness of at least 7 and high strength.

Although the hollow silica particles, the method of manufacturing the same, the composition including the same and the sheet with inner cavities have been described with reference to the specific embodiments, they are not limited thereto. Therefore, it will be readily understood by those skilled in the art that various modifications and changes can be made thereto without departing from the spirit and scope of the present invention defined by the appended claims.

What is claimed is:

1. Hollow silica particles having oil absorption ratio of at most about 0.1 ml/g, porosity of hollow silica particles when mixed with a resin of at least about 90%, and melting temperature (Tm) in the range from about 130 to about 200° C., the hollow silica particles comprising a silicon compound comprising an organic group as a main component.

2. The hollow silica particles of claim 1, wherein a surface of the hollow silica particles consists of at least one functional group selected from the group consisting of an —OH group, a methyl group, an ethyl group, a phenyl group, an acryl group, and an epoxy group.

3. The hollow silica particles of claim 1, wherein coefficient of variation of particle distribution (CV) is at most about 10%.

4. The hollow silica particles of claim 1, wherein sphericity is at least about 0.9.

5. The hollow silica particles of claim 1, wherein the hollow silica particles comprise a shell having a thickness and the thickness is from about 10 to about 50% of an average particle diameter of the particles.

6. A method of manufacturing hollow silica particles, comprising the steps of:
(a) forming silane droplets by adding alkoxysilane in an aqueous solution and stirring;
(b) hydrolyzing the silane droplets by adding an acid in the aqueous solution including the alkoxysilane;
(c) forming first particles through bonding between the silane droplets by adding an aqueous alkaline solution in the reaction solution of step (b);
(d) forming shells by polymerizing the first particles by stirring the reaction solution including the aqueous alkaline solution;
(e) forming cavities by etching the inner part of the shells using an organic solvent; and
(f) filtering a solution and drying.

7. The method of manufacturing hollow silica particles of claim 6, wherein the first particles have a PPSQ structure.

8. The method of manufacturing hollow silica particles of claim 6, wherein the alkoxysilane is at least one selected from phenyl-based alkoxysilane and alkoxysilane having an organic group other than a phenyl group, or a mixture thereof.

9. The method of manufacturing hollow silica particles of claim 6, wherein a mixture of the alkoxysilane is obtained by mixing at least about 80 wt % of phenyl-based alkoxysilane and at most about 20 wt % of alkoxysilane having an organic group other than a phenyl group.

10. The method of manufacturing hollow silica particles of claim 6, wherein the phenyl-based alkoxysilane is PTMS.

11. The method of manufacturing hollow silica particles of claim 6, wherein pH of the reaction solution after adding the acid in step (b) is in a range of from about 1 to about 5.

12. The method of manufacturing hollow silica particles of claim 6, wherein stirring time in step (b) is in a range of from about 0.5 minutes to about 10 minutes.

13. The method of manufacturing hollow silica particles of claim 6, wherein pH of the reaction solution after adding the aqueous alkaline solution in step (c) is at least about 10.

14. The method of manufacturing hollow silica particles of claim 6, wherein the aqueous alkaline solution is a NH₄OH solution or an alkylamine solution selected from the group consisting of tetramethyl ammonium hydroxide (TMAH), octylamine (OA, CH₃(CH₂)₆CH₂NH₂), dodecylamine (DDA, CH₃(CH₂)₁₀CH₂NH₂), hexadecylamine (HAD, CH₃(CH₂)₁₄CH₂NH₂), 2-aminopropanol, 2-(methylphenylamino)ethanol, 2-(ethylphenylamino)ethanol, 2-amino-1-butanol, (diisopropylamino)ethanol, 2-diethylaminoethanol, 4-aminophenylaminoisopropanol, N-ethylaminoethanol, monoethanolamine, diethanolamine, triethanolamine, monoisopropanolamine, diisopropanolamine, triisopropanolamine, methyldiethanolamine, dimethylmonoethanolamine, ethyldiethanolamine, and diethylmonoethanolamine.

15. The method of manufacturing hollow silica particles of claim 6, wherein a reaction temperature in steps (b) and (d) is in a range from about 40 to about 80° C.

16. The method of manufacturing hollow silica particles of claim 6, further comprising the step of (g) sonicating a filtered material after performing filtering in step (f).

17. A composition comprising the hollow silica particles according to claim 1, a resin, and a solvent.

18. The composition of claim 17, wherein the hollow silica particles are comprised at a ratio in a range of about 30 to about 80 wt % based on the total amount of the composition.

19. The composition of claim 17, wherein the resin is comprised at a ratio in a range of about 20 to about 70 wt % based on the total amount of the composition.

20. The composition of claim 17, wherein the resin is a thermosetting resin or a UV curable resin of which initial curing temperature is lower than the melting temperature (Tm) of the hollow silica particles.

21. The composition of claim 20, wherein the thermosetting resin is at least one selected from a phenol resin, an epoxy resin, and a melamine resin, or a mixture thereof.

22. The composition of claim 20, wherein the UV curable resin is an acrylate-based polymer resin.

23. The composition of claim 20, wherein the resin further comprises at least one selected from the group consisting of a polyimide (PI) resin, a C-PVC resin, a PVDF resin, an ABS resin, and CTFE in addition to the thermosetting resin and the UV curable resin.

24. The composition of claim 17, further comprising at least one selected from a hard coating agent, a UV blocking agent, and an IR blocking agent.

25. A sheet comprising a base, and a coating layer formed on the base and including a resin as a main component, the coating layer comprising a plurality of inner cavities formed therein, and components of hollow particles being attached to a portion of an inner circumference of the inner cavities.

26. The sheet of claim 25, wherein the components of the hollow particles comprise silicon compounds comprising an organic group.

27. The sheet of claim 25, wherein the plurality of the inner cavities are separated from each other.

28. The sheet of claim 25, wherein a diameter of the inner cavities is at least 40 nm.

29. The sheet of claim 25, wherein a diameter of the inner cavities is at most 500 nm.

30. The sheet of claim 25, wherein the resin is a thermosetting resin or a UV curable resin.

31. The sheet of claim 25, wherein the coating layer has UV blocking function and IR blocking function.

32. The sheet of claim 25, wherein the sheet has insulation function.

33. The sheet of claim 25, wherein the base is a sheet of a polymer material, a fiber, a film or glass.

34. A method of manufacturing a sheet, comprising the steps of:
(a) forming a coating layer by coating the composition according to claim 17 on a base;
(b) curing the coating layer; and
(c) forming a plurality of inner cavities by melting hollow silica particles in the coating layer.

35. The method of manufacturing a sheet of claim 34, wherein the curing in step (b) is performed by heat curing or UV curing.

36. The method of manufacturing a sheet of claim 35, wherein a curing temperature during the heat curing is lower than a melting temperature (Tm) of the hollow silica particles.

37. The method of manufacturing a sheet of claim 34, wherein the hollow silica particles are melted by heat or microwave.

38. The method of manufacturing a sheet of claim 37, wherein a melting temperature of the hollow silica particles is in a range of from about 130 to about 200° C.
